(19) United States
(12) Patent Application Publication
(10) Pub. No.: US 2024/0176363 A1
(43) Pub. Date: May 30, 2024

(54) AN AUTONOMOUS DELIVERY VEHICLE

(71) Applicant: Pravaig Dynamics Private Limited, Delhi (IN)

(72) Inventors: Dhawal KHULLAR, Jaipur (IN); Siddhartha BAGRI, New Delhi (IN)

(21) Appl. No.: 18/284,540

(22) PCT Filed: Mar. 8, 2022
(86) PCT No.: PCT/IB2022/052058

§ 371 Date: Sep. 28, 2023

(30) Foreign Application Priority Data
Mar. 31, 2021 (IN) 202141015090

(51) Int. Cl. G05D 1/248; B60P 3/00; B62D 29/04; B65D 88/52; B65D 88/58; G05D 105/28

(52) U.S. Cl. CPC G05D 1/248; B60P 3/007; B62D 29/04; B65D 88/52; B65D 88/58; G05D 2105/28

(57) ABSTRACT

The present invention discloses an autonomous unmanned vehicle (500) designed to absorb collision impact for delivering the packages to the delivery destinations. The unmanned vehicle (500) is capable of operating autonomously on paved roadways or pathways. The present invention includes a hollow platform (107) for enclosing control systems, a bottom frame (106) secured to the hollow platform (107) for receiving a load, a top frame (103) for sheltering the load from the top; a collapsible shell (109) forming an encasing for enclosing the load, having protrusions for protection of load from collision impact, a plurality of retractable members (104) for expanding and contracting of the shell structure, a plurality of outwardly protruding wheels (108) configured at each corner of the hollow platform (107) for vehicle movement, and a driving mechanism for controlling toggling movement of the retractable members (104) between various positions. In consideration that the vehicle does not carry passengers, the size and/or motor power of the vehicle may be significantly reduced as compared to conventional passenger vehicles.

### FIELD OF THE INVENTION

The present invention relates to an autonomous delivery vehicle. Particularly, the present invention discloses an automated unmanned vehicle that is suitable to run on road or pathway such as footpath or walkway for delivering the packages to the delivery destinations designed to absorb collision impact.

### BACKGROUND OF THE INVENTION

As the technology is enhancing E-commerce has evolved on larger platform. People are more inclined towards virtual or remote shopping. Now, remote shopping provides many benefits to its customers such as shopping from anywhere in the world and eliminating the need to physically reach any store or shopping mall for purchasing any item. Further, variety of items that are available on different stores are all available virtually on a single mobile application.

However, remote shopping though being so resourceful faces one prominent drawback i.e. the delay in time between purchasing an item and having it delivered to the customer. Companies have tried to minimize the time delay between purchase and delivery by providing same day delivery in certain cities which is again very costly and uneconomical as it requires a large number of individuals on call to go out to different location and deliver items as they are purchased.

One of the emerging methods in improved delivery service that does not have the draw backs of conventional delivery, is the use of unmanned aerial vehicles/drones. Drones can be used to carry and deliver small to medium sized packages, directly to known locations, using global positioning system technology, telemetry, metadata and/or commands from a remote operator.

As consumer demand for same day delivery rises, drones will rapidly become a viable technology for many delivery services and companies. However, despite its many advantages, one of the potential problems of using drones to deliver packages is its failure to deliver heavy loaded packages.

Delivery companies are inclining towards the new form of delivery that is, delivery through autonomous vehicles. But, to revolutionize the autonomous delivery service, it is imperative that the proper infrastructure is developed which enables successful implementation of drone delivery or delivery by other autonomous vehicles.

In an urban environment, mild impacts/nudges with human traffic and other stationary/moving objects are inevitable. Therefore, considering that autonomous driving technology is still evolving there is a need for development of a vehicle which can sustain the edge case errors in judgement by the autonomous driving systems as they are learning, while minimizing the risk factors to its environment.

### OBJECTIVE OF THE INVENTION

The primary objective of the present invention is to provide an automated unmanned vehicle suitable to run on road or pathway such as footpath or walkway for delivering the packages to the delivery destinations.

Another objective of the present invention is to provide an automated unmanned vehicle for safe delivery of packages.

Another objective of the present invention is to provide a vehicle having a collapsible shell for encasing a load.

Yet another objective of the present invention is to provide a delivery vehicle having a load carrying shell that can be expanded or contracted depending on load size.

Still another object of the present invention is to provide a collapsible shell designed to reduce accidental contact damage.

Yet another objective of the present invention is to provide a collapsible shell designed to absorb the impact of collision with any vehicle or any human being.

Other objectives and advantages of the present invention will become apparent from the following description taken in connection with the accompanying drawings, wherein, by way of illustration and example, the aspects of the present invention are disclosed.

### BRIEF DESCRIPTION OF DRAWINGS

The present invention will be better understood after reading the following detailed description of the presently preferred aspects thereof with reference to the appended drawings, in which the features, other aspects and advantages of certain exemplary embodiments of the invention will be more apparent from the accompanying drawing in which:

FIG. 1 illustrates an exploded view of the autonomous delivery vehicle.

FIGS. 2 and 3, illustrate a perspective view of the shell of the autonomous delivery vehicle in expanded state.

FIGS. 4 and 5 illustrate a perspective view of the shell of the autonomous delivery vehicle in collapsed state;

FIGS. 6a, 6b and 6c illustrate a perspective view of the shell of the autonomous delivery vehicle in tilted state, wherein FIGS. 6b and 6c illustrate loading and unloading of the package respectively.

FIGS. 7 and 8 illustrate the perspective view of the retractable members.

FIGS. 9, 10, 11 and 12 illustrate the perspective view of the retractable members connected with single motor;

FIGS. 13 to 16 illustrate the perspective view of the retractable members connected with dual motor;

FIGS. 17 to 20 illustrate the tilted movement of the retractable members along with top frame of the autonomous delivery vehicle.

### SUMMARY OF THE INVENTION

The present invention discloses an autonomous unmanned vehicle for delivering the packages to the delivery destinations. The autonomous delivery vehicle is capable of adjusting itself according to the load size and is designed for absorbing collision impact. The unmanned vehicle is capable of operating autonomously on paved roadways or pathways such as footpath or walkway. The vehicle has a control system for autonomous driving on road. The vehicle also has a collapsible compartment for carrying the delivery items that can change its volume according to the size of load. Further the vehicle also has peripheral components such as a headlight, position lamps and brake or brake-lights to increase the visibility of the vehicle. In consideration that the vehicle does not carry passengers, the size and/or motor power of the vehicle may be reduced as compared to conventional passenger vehicles.

### DETAILED DESCRIPTION OF INVENTION

The following detailed description and embodiments set forth herein below are merely exemplary out of the wide variety and arrangement of instructions which can be employed with the present invention. The present invention may be embodied in other specific forms without departing from the spirit or essential characteristics thereof. All the features disclosed in this specification may be replaced by similar other or alternative features performing similar or same or equivalent purposes. Thus, unless expressly stated otherwise, they all are within the scope of the present invention.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings but are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps, or components but does not preclude the presence or addition of one or more other features, integers, steps, components, or groups thereof.

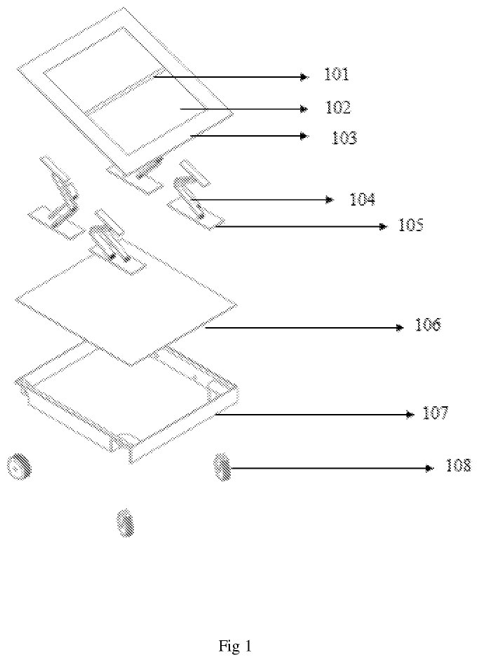

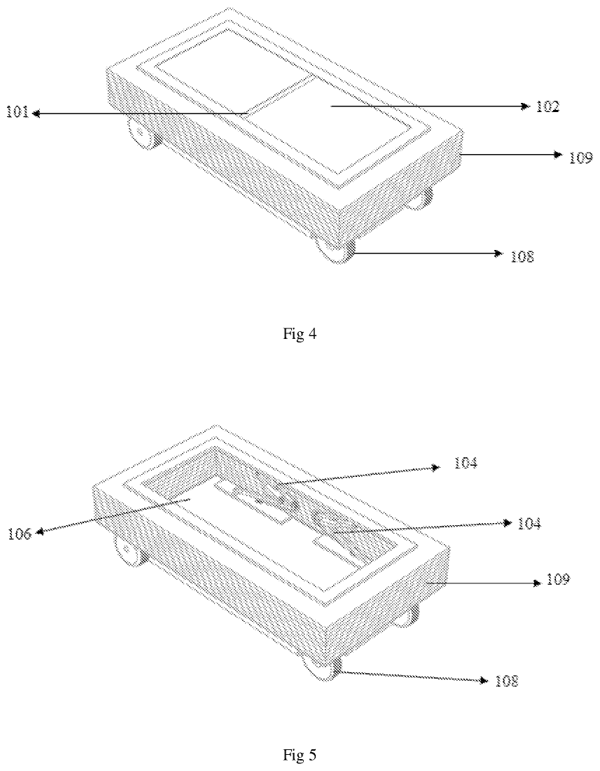

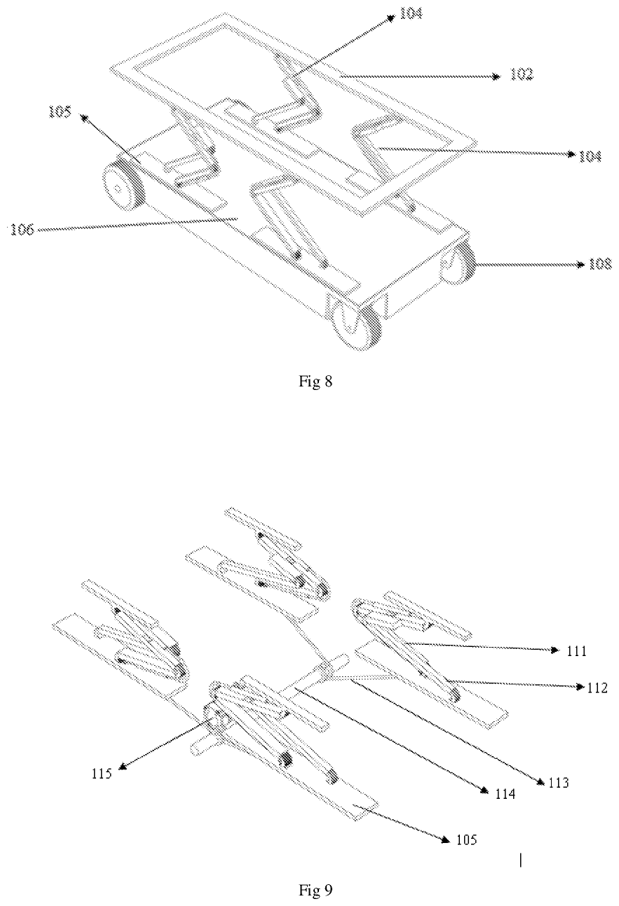

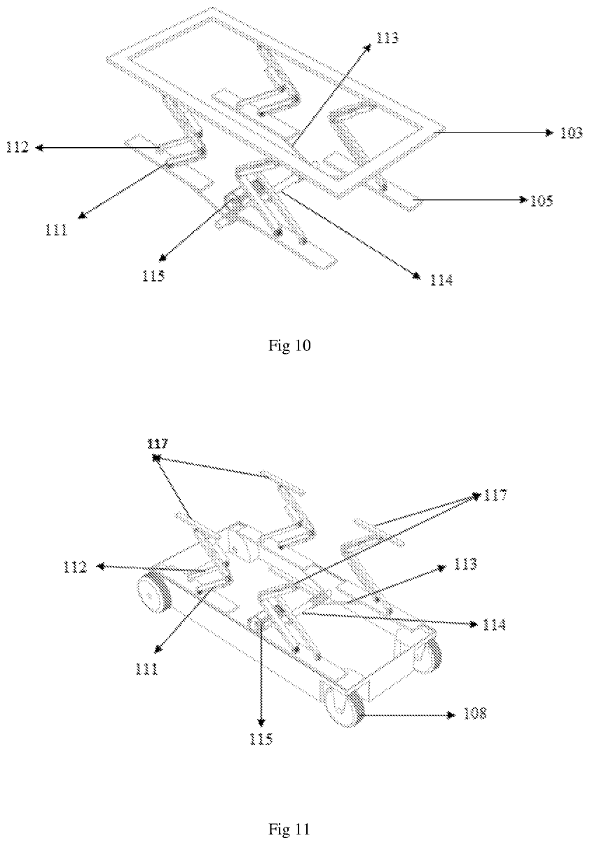

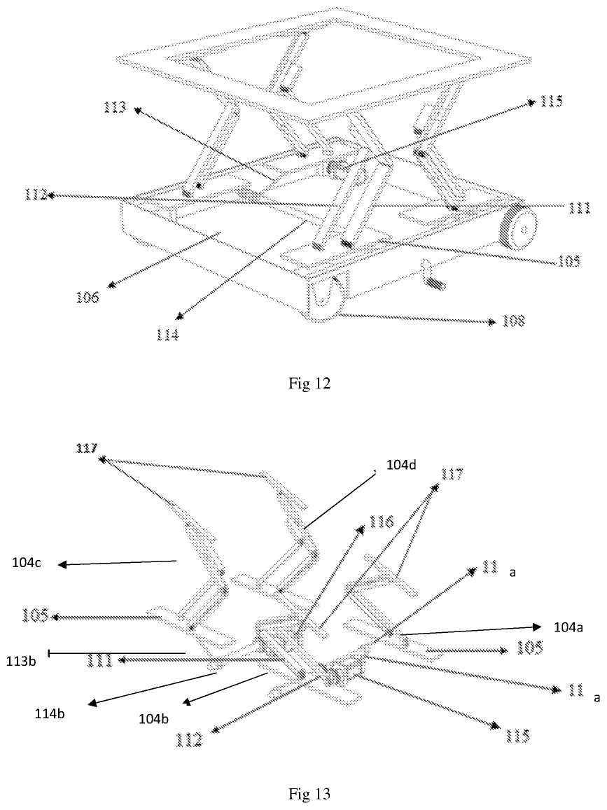

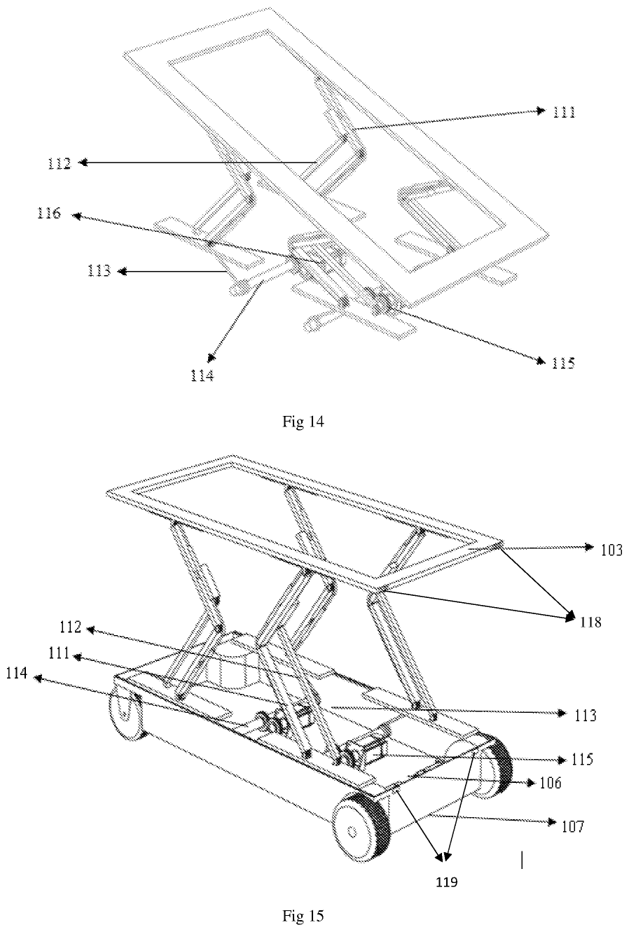

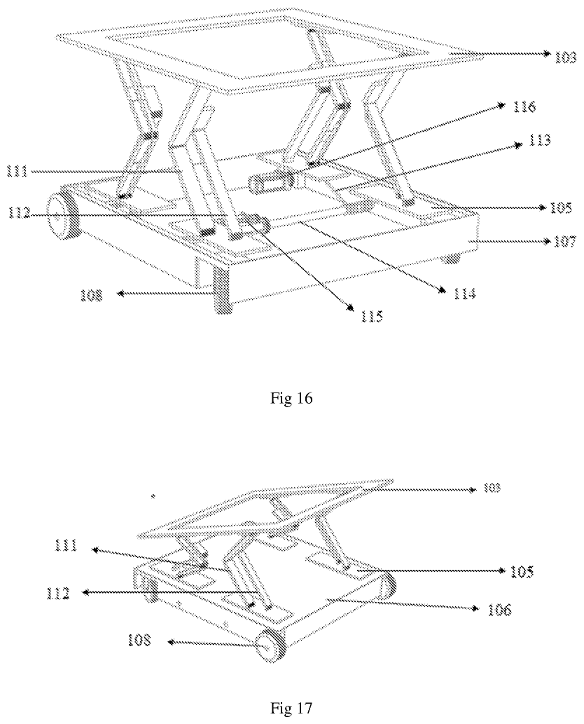

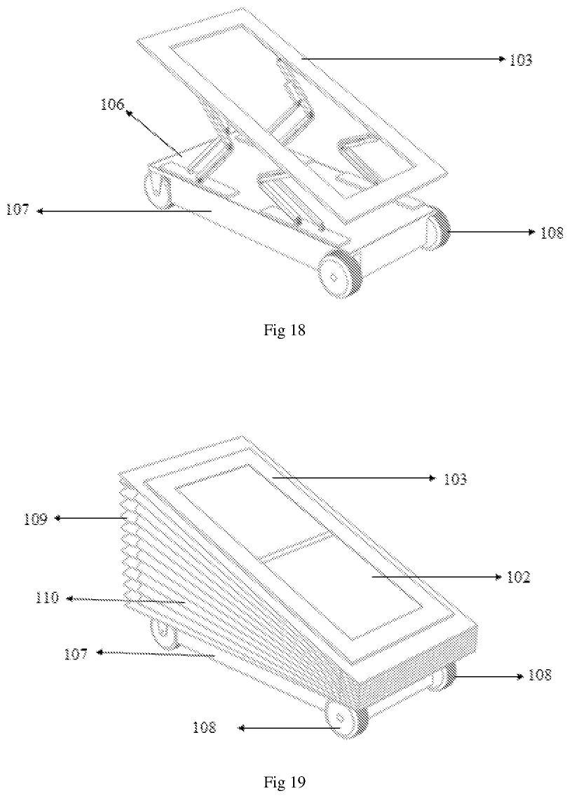

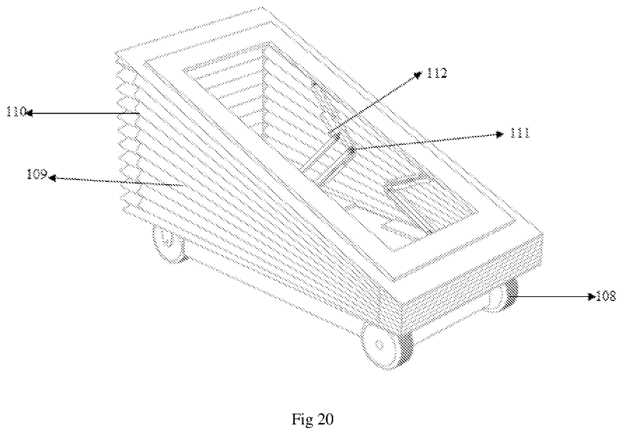

The present invention relates to an autonomous delivery vehicle (500), also referred to as an unmanned ground vehicle or a vehicle hereinafter and its use for transporting tangible goods, such as packages, retail goods, or other items. FIGS. 1 to 20 illustrate the system (500) of the present invention which will be explained in further detail below. The unmanned vehicle (500) of the present invention is designed for operating on paved roadways i.e., streets, roads, highways, freeways, avenues, boulevards, bridges, tunnels, pathways, footpaths, walkways etc. The vehicle (500) of the present invention may have a relatively smaller size and configured to travel at a relatively slower speed as compared to conventional passenger cars. However, because the vehicle (500) is designed for traveling on conventional roadways, the vehicle proficiently maintains speed to keep pace with other modes of transportation. Further, the vehicle (500) of the present invention is designed to absorb an impact from a collision with any vehicle, a human being, an animal, a bird, or any type of barrier while running on road, footpath, walkway or other pathways.

FIG. 2 provides an isometric view of the autonomous delivery vehicle (500) in accordance to a preferred embodiment of the present invention. The system (500) includes a platform (107). The platform (107) forms a structural base of the system (500). Referring to FIG. 1, an exploded view of the system (500), the platform (107) is hollow. A hollow space in the platform (107) harbors a plurality of control systems, a power source for energizing the system and its allied functions. A bottom frame (106) is disposed onto the platform (107) and encases and confines the plurality of control systems, the power source in the hollow space of the platform (107). The bottom frame (106) may be secured to the platform by any means, or it may be integrated with the platform (107) as a single unit. The bottom frame (106) also serves as the load carrying surface. The bottom frame may have a means for securing the load/package onto the frame so that the package remains stationery while transportation. In an embodiment, the load may be secured to the bottom frame by means of a Velcro or a strap arrangement. In an alternate embodiment, an additional arrangement such as forklift pallet, antiskid layer, protector pads etc. may be configured on the bottom frame for safe delivery of the packages/load.

The system (500) further includes a shell (109). The shell (109) is disposed between the bottom frame (106) and a top frame (103) of the system (500). The shell (109) forms a main body of the autonomous vehicle (500). The shell (109) encases an area between the bottom frame (106) and the top frame (103) defining an interior space for encasing a load. The shell (109) is configured to be connected to the bottom frame (106) through its bottom edge (109a) and the top frame (103) through its top edge (109b) respectively. Further, the shell (109) has a layered and filleted (110) structure on its surface. These layered and filleted structures (110) on the surface contribute to collapsibility of the shell (109). Further, the surface of the shell (109) has a plurality of protrusions. In a preferred embodiment, the plurality of protrusions (111) extends outside the platform (107) to form a crumple zone around the core of vehicle encasing the load. The protrusions (111) of the shell (109) are configured to absorb collision impact. The protrusions (111) reduce damage caused to the platform (107) and also to the collided vehicle or a human being. Further, the shell is made up of soft material designed to absorb collision impact. In an embodiment, the shell (109) is made up of a laminated poly urethane (Laminated PU).

Further, the top frame (103) of the system (500) includes an opening (102). The opening (102) provides an access to the bottom frame (106) which holds the load. The opening (102) is closed using a zipper (101) or any other methods known allowing the load to be placed on the bottom frame (106) and secured on the platform (107) and protected from any kind of damage. Further, the zipper (101) is either provided with a manual lock or a digital lock. In a preferred embodiment, the zipper (101) is secured using the digital lock. The lock can be opened using a code provided to a receiver allowing access into the system (500) to retrieve the goods or package. In an alternate embodiment of the invention, the opening 102 is closed using magnets and magnetic locks. The magnetic locks are preferred being more secure and reliable as they are difficult to hack, have high strength and provide fast access while loading and unloading.

A plurality of wheels (108) is disposed at each corner of the platform (107). In a preferred embodiment, four wheels (108) are configured at each corner of the platform (107) wherein a part of the wheel protrudes outside the platform (107). Further, two castor wheels are placed in front, and two drive wheels with separate drive motors at rear may be provided to the platform for navigation to various locations, which forms a second barrier in case of collision from hitting directly to the platform (107). Therefore, if the vehicle collides with any barrier then firstly the impact is absorbed by the shell (109) and followed by the wheels (108) acting as a barrier to direct damage to the platform (107).

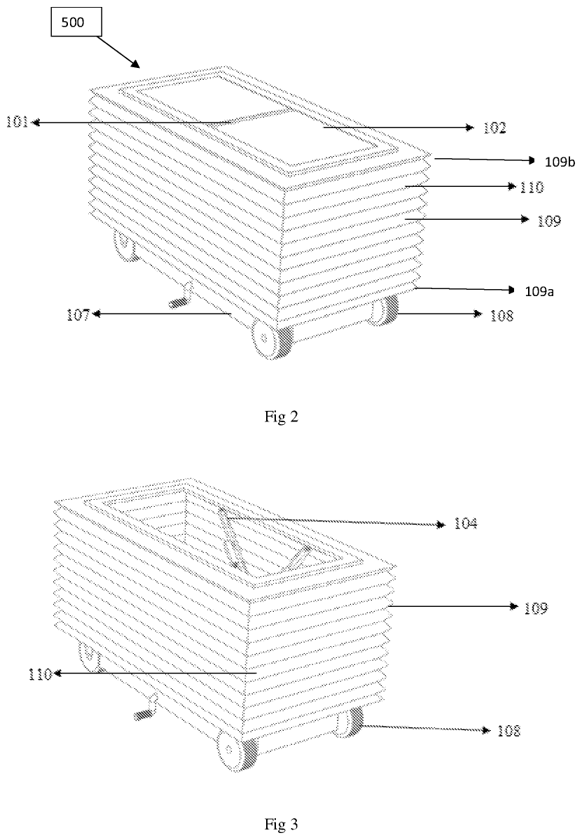

FIG. 7 is a perspective view of a plurality of retractable members (104) of the system (500). In a preferred embodiment of the present invention, there are four retractable members (104). Each of the retractable members (104) are disposed at each corner of the platform (107). Further, each of the four retractable members (104) are attached to the bottom frame (106) through its first end (104a′) while through its second end (104a″) are attached to the top frame (103). In a preferred embodiment of the present invention, the retractable members are attached to the bottom frame (106) and the top frame (103) through a pallet (105). Further, each of the retractable members (104) includes a primary arm (111) and a secondary arm (112). The secondary arm (112) is configured to rest on a surface of the primary arm (111). The primary arm (111) and the secondary arm (112) utilize a compliant joint. This allows minimizing part count and complexity in the design. Further, a fixed gap (113) is maintained between a first end of the primary arm (111) and a first end of the secondary arm (112) attached to the pallet (105) disposed on the bottom frame (106). A second end of the primary arm (111) is attached to the pallet (117) disposed on the top frame (103). The fixed gap (113) maintained between the primary arm (111) and the secondary arm (112) allows a free movement of the primary arm (111). The primary arm (111) is designed to achieve a variable height. The primary arm (111) is configured to toggle between an upward direction, a downward direction, and other intermediate positions. Further, a second end of the secondary arm (112) rests on a surface of the primary arm (111). The secondary arm (112) provides structural integrity to the primary arm (111) and further, restricts a degree of freedom of the primary arm (111) in other planes. Thus, a movement of the primary arm (111) along with the secondary arm (112) in the upward direction or/and the downward direction causes the shell (109) to either open or close. The shell (109) may have a fixed volume or a variable volume. In the preferred embodiment of the present invention, referring to FIGS. 3 and 5, the variable volume is achieved as a result of the expansion and/or contraction of the layered and filleted structure (110) of the shell (109). Thus, based on the size of a load placed on an area of the bottom frame (106), the shell (109) can either expand or contract by movement of the retractable members (104).

FIGS. 9 to 13 illustrate a perspective view of a driving mechanism of the system (500). The driving mechanism is configured to the retractable arms (104). The driving mechanism allows the retractable arms (104) to toggle between the upward direction, the downward direction, and intermediate positions. The driving mechanism includes a string (113) from each of the retractable members (104) coiled around a rod (114). The movement of the retractable members (104) can be either achieved automatically by connecting the rod (114) to a motor or manually by connecting the rod (114) to a rotator. The driving mechanism toggles the retractable members (104) between the upward direction, a downward direction, and various intermediate positions. This movement of the retractable members (104) is achieved as a result of a rotation of the motor, or the rotator as follows:
a) a clockwise movement of the motor or the rotator causes the string to tighten around the rod causing the retractable member (104) to move in the upward direction causing the shell (109) to expand; while.
b) an anticlockwise movement of the motor or the rotator causes the strings to loosen around the rod causing the retractable member (104) to move in the downward direction, causing the shell (109) to contract.

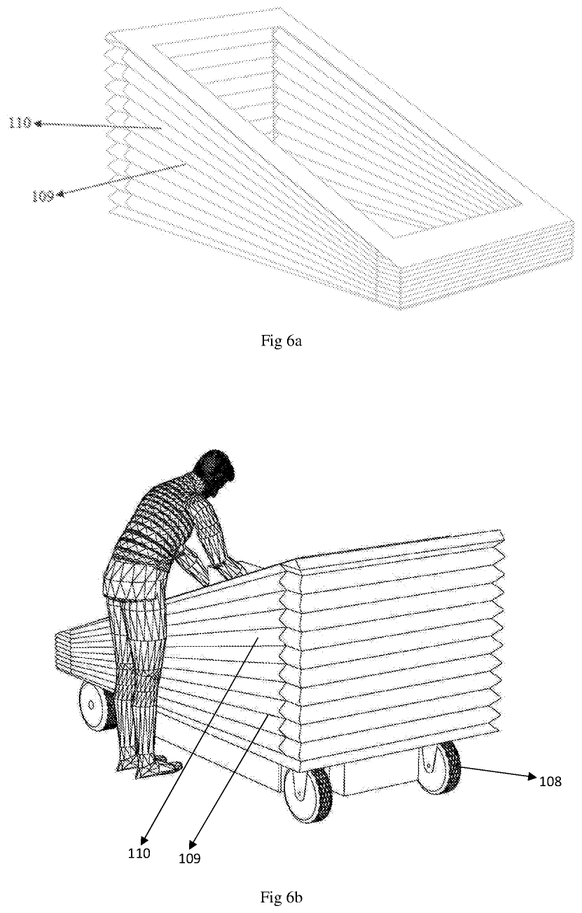

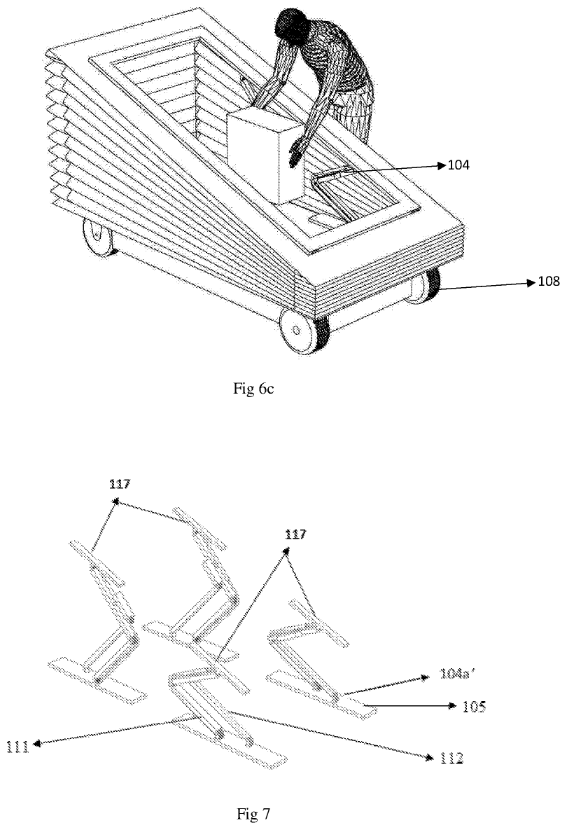

In the preferred embodiment of the present invention, as depicted in FIG. 13, a string (113a) from each of two retractable members (104a & 104b) disposed along a first breadth of the platform (107) is coiled around a first rod (114a) while a string (113b) from each of two retractable members (104c & 104d) disposed along a second breadth of the platform (107) is coiled around a second rod (114b) disposed in the hollow space of the platform (107). Further, the first rod (114a) and the second rod (114b) are configured to a first motor (115) and a second motor (116) respectively. The attachment of each of the rods (114a & 114b) to each of the motors (115 & 116) causes each of the two retractable members (104) disposed at the first breadth and the second breadth of the platform (107) respectively to move independent of each other. This assembly allows the top frame (103) to achieve a tilted configuration as depicted in FIG. 6. The tilted configuration of the top frame (103) along with the shell (109) provides easy access to the load placed on the bottom frame (106) of the platform (107). In another embodiment of the present invention, as depicted in FIGS. 9-12, a string from each of the retractable members (104) is coiled around a common rod (114) attached to a motor (115). This assembly allows all the retractable members (104) of the system (500) to move in a coordinated fashion. In an alternate embodiment, a string (113a, 113b, 113c & 113d) from each of the retractable members (104a, 104b, 104c and 104d) is coiled around individual rods (114a-d), this assembly allows a movement of each of the retractable members (104) independent of each other.

The control system comprises a battery system, a motor, a navigation system, a controller, a suspension, a braking mechanism, and anti-collision system etc. for unmanned functioning of the autonomous vehicle. The hollow platform (107) is surfaced with headlights, position lamps and brake, brake-lights, or a combination thereof.

In the present invention the vehicle's navigation system may use a Global Positioning System that may utilize a map that, in addition to the roadways and navigational information, further contains specific information about traffic or roadway infrastructure features. This information may be acquired in any suitable manner, such as by mapping the area in which the vehicle will operate.

In the present invention the vehicle has a control system for its autonomous driving capability. The control system includes a plurality of sensors (i.e., motion sensors, ultrasonic sensors, wheel speed sensor, LIDAR etc.) (119) for controlling movement of the vehicle, speakers for warning the pedestrian or interacting with the people nearby; detectors, emitters (e.g., radio, conventional light, laser), drive motors and mechanical parts, mirrors, etc. In the preferred embodiment of the present invention, peripheral components such as the plurality of sensors (119) which includes LIDAR, speed sensors etc. are located on an outer surface of the platform (107) placed along its breadth on both sides, referring to FIG. 15.

The delivery vehicle of the present invention is equipped with peripheral components such as headlights, position lamps and brake, brake-lights, or a combination thereof (118) mounted on the hollow platform (107) or any other part of the vehicle that operates while traveling on a roadway. This may be useful to increase the visibility of the vehicle to other transportations. In the preferred embodiment of the present invention, the position lamps and or lights (118) are provided on an outer surface of the top frame (103) along its breadth, on both sides as shown in FIG. 15. The unmanned vehicle's control system may be also programmed to monitor the technical or mechanical state/condition of the vehicle for example, mechanical problem (e.g., flat tire), electrical problem (e.g., light beacon not working), electromechanical problem (e.g., electric motor malfunction), communication problem (e.g., loss of communication link), low battery charge, or low fuel. The encountered problems may receive response as programmed in the vehicle.

Since the vehicle is not designed to carry passengers, the suspension design can be different from those typically used in contemporary passenger cars. The wheels (108) are protruded outwards to lower down the collision impact. The wheels (108) are positioned such that a part of the wheel protrudes outside the hollow platform (107) which forms a second barrier in case of collision from hitting directly to the platform. Therefore, if the vehicle collides with any barrier then firstly the impact is absorbed by the collapsible shell (109) and afterwards the wheels prevent the barrier from colliding with the platform (107) directly.

The unmanned vehicle (500) is energized by any suitable power source, including conventional power sources such as gasoline or diesel, or alternative renewable power resources in combination such as battery-electric, natural gas, fuel cell, hybrid-electric, etc., or any combination thereof. Because the unmanned vehicle may be making mostly short trips, the unmanned vehicle (500) may be powered by range-limited power sources, such as by electricity accumulator apparatus (e.g., batteries or capacitors). In some cases, the vehicle may be hybrid-powered, i.e., electrically powered in combination with a fuel engine. In an exemplary embodiment the present invention utilizes a battery system.

In the present invention the reference numerals with respect to the components of the present invention is enlisted below:

| Sr. No. | Components of the system | Reference Numerals |
|---|---|---|
| 1. | Zipper | 101 |
| 2. | Opening | 102 |
| 3. | Top Frame | 103 |
| 4. | Retractable Member | 104 |
| 5. | Pallet disposed at bottom frame | 105 |
| 6. | Bottom Frame | 106 |
| 7. | Hollow Platform | 107 |
| 8. | Wheels | 108 |
| 9. | Shell | 109 |
| 10. | Filleted Structures | 110 |
| 11. | Primary Arm | 111 |
| 12. | Secondary Arm | 112 |
| 13. | String | 113 |
| 14 | Rod | 114 |
| 15. | Motor M1 | 115 |
| 16. | Motor M2 | 116 |
| 17. | Pallet disposed at top frame | 117 |
| 18. | Peripheral components (position | 118 |
| | lamp(s)/sensor(s)/light(s) on top | |
| | frame | |
| 19. | a Plurality of sensors | 119 |

In accordance with the present invention the advantages of the unmanned vehicle having low impact feature are:
a. allowing movement of the autonomous vehicle through the roads instead (in addition to) of the footpath;
b. minimizing collision impact through the filleted structure of the shell layered outside the platform and the protruding wheels, hence reducing damage to the goods.

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

1. An autonomous delivery vehicle (500) comprising:
a platform (107) having a hollow space for encasing a plurality of control system,
a bottom frame (106) covering the hollow platform (107) for encasing the plurality of control systems,
a top frame (103), wherein the top frame (103) of the vehicle (500) includes an opening (102), the opening (102) provides an access to the bottom frame (106) which holds the load and is closed using a zipper (101) using the digital lock;
a shell (109) having a plurality of protrusions wherein the shell (103) is disposed between the bottom frame (106) and the top frame (103) and configured to define an interior space for encasing a load, wherein
a plurality of retractable members (104) configured between the bottom frame (106) and the top frame (103) of the vehicle (500),
a plurality of outwardly protruding wheels (108) configured at each corner of the platform (107),
a plurality of peripheral components (118), and a plurality of sensors (119) disposed on platform and the top frame for visibility and vehicle control; and
a driving mechanism coupled to the plurality of retractable members (104); wherein:
the driving mechanism controls toggling movement of the retractable members (104), in turn causing the shell (109) to either expand or contract providing a variable volume based on a volume of a load on the platform (109);
a part of the plurality of wheels (108) along with the plurality of protrusions extends outwardly from the surface of the shell (109) and protruding outside the platform (109) to absorb an impact caused in a collision and reduce damage to the platform (109) and to a colliding vehicle or a human being or any other object; and
a vehicle navigation system.

2. The autonomous delivery vehicle (500) as claimed in claim 1, wherein the plurality of the retractable members (104) are disposed between the bottom frame (106) and the top frame (103).

3. The autonomous delivery vehicle (500) as claimed in claim 1, wherein each of the plurality of the retractable members (104) comprises a primary arm (111) and a secondary arm (112).

4. The autonomous delivery vehicle (500) as claimed in claim 3, wherein the primary arm (111) through its first end and the secondary arm (112) through its first end are attached to a pallet (105) which in turn is fixed to surface of the bottom frame (106) and primary arm (111) through its second end is attached to a pallet (117) which in turn is fixed to surface of the top frame (103).

5. The autonomous delivery vehicle (500) as claimed in claim 3, wherein the primary arm (111) and the secondary arm (112) have a fixed gap allowing the primary arm (111) to move freely between the upward direction, the downward direction, and other intermediate positions.

6. The autonomous delivery vehicle (500) as claimed in claim 3, wherein the secondary arm (112) through its second end rests on the primary arm (111).

7. The autonomous delivery vehicle (500) as claimed in claim 3, wherein the secondary arm (112) is designed to provide a structural integrity to the primary arm (111) by limiting its degree of freedom (111).

8. The autonomous delivery vehicle (500) as claimed in claim 1, wherein the system (500) includes a plurality of control system disposed in a hollow space of the platform (109).

9. The autonomous delivery vehicle (500) as claimed in claim 1, wherein the plurality of control system includes a battery system, a motor, the vehicle navigation system comprising a Global Positioning System, a controller, a suspension, a braking mechanism, and anti-collision system etc. for unmanned functioning of the autonomous vehicle.

10. The autonomous delivery vehicle (500) as claimed in claim 1, wherein the driving mechanism for the plurality of retractable members (104) includes a string (113) coiled around a common rod (114) configured to a rotating mechanism.

11. The autonomous delivery vehicle (500) as claimed in claim 10, wherein the rotating mechanism includes a motor or a rotator.

12. The autonomous delivery vehicle (500) as claimed in claim 10, wherein the plurality of the retractable members (104) are toggled between the upward direction, the downward direction and various intermediate positions through a rotation of a motor or a rotator: wherein
a clockwise rotation of the motor tightens the string thereby making the plurality of retractable members move in an upward direction causing the shell (109) to expand.
an anticlockwise rotation of the motor loosens the string thereby making the plurality of retractable members (105) move in a downward direction causing the shell (109) to contract.

13. The autonomous delivery vehicle (500) as claimed in claim 10, wherein the plurality of retractable members (104) includes four retractable members (104), each disposed at each corner of the platform (107) on the bottom frame (106) through a pallet (105).

14. The autonomous delivery vehicle (500) as claimed in claim 10, wherein the retractable members (104) include a first pair of retractable members (104a & 104b) through its strings (113a & 113b) coiled around a first rod (114a) attached to a first motor (115) and a second pair of retractable members (104c & 104d) through its strings (113c & 113d) coiled around a second rod attached to a second motor (116), allowing each of the pair of retractable members (104a & 104b) and (104c & 104d) to achieve a tilted configuration.

15. The autonomous delivery vehicle (500) as claimed in claim 10, wherein the retractable members (104) include four retractable members and wherein a string (113a, 113b, 113c & 113d) from each of the four retractable members are coiled around individual rods (114a-d), allowing an independent movement of each of the four retractable arms (104).

16. The autonomous delivery vehicle (500) as claimed in claim 10, wherein the strings (113) from each of the retractable members (104) is coiled around a common rod (114) attached to a single motor (115), causing all the retractable members (104) to move in a coordinated fashion.

17. The autonomous delivery vehicle (500) as claimed in claim 1, wherein the shell (109) is made up of soft collision absorbing material including but not limited to laminated poly urethane.
